(19) United States
(12) Patent Application Publication
(10) Pub. No.: US 2010/0294144 A1
(43) Pub. Date: Nov. 25, 2010

(54) Precision press

(76) Inventor: Jürgen Fahrenbach, Aichelberg (DE)

Correspondence Address: KLAUS J. BACH, 4407 TWIN OAKS DRIVE, MURRYSVILLE, PA, 15668, US

(21) Appl. No.: 12/584,537

(22) Filed: Sep. 8, 2009

(30) Foreign Application Priority Data
May 19, 2009 (DE) 10 2009 021 861.0

(51) Int. Cl. B30B 1/00

(52) U.S. Cl. 100/268

(57) ABSTRACT

In a press with a plunger which is supported by an elastically deformable support structure so as to be linearly movable but otherwise rigidly engaged and with a drive arrangement for the controlled movement of the plunger, the drive arrangement includes no friction or antifriction support joints so that the plunger guide structure is not affected by position errors generated by oil films in bearings or wear of bearings generated by the high press forces effective during operation of the press which could squeeze oil films out of bearing gaps.

### BACKGROUND OF THE INVENTION

The invention resides in a press which is constructed particularly for producing work pieces with diffraction-active structures.

Conventional presses for shaping, stamping, embossing and cutting include generally a plunger, which is supported in slide or roller bearing guide structures. Furthermore, the plunger is driven for example by one or several reciprocating connecting rods. Slide bearings used for the connection of the connecting rods have in general a certain play and also generate heat. Bearings with little or no play have the disadvantage of increased heat generation which may detrimentally affect the accuracy of the product being manufactured. The detrimental effects increase with increasing operating speed of the respective presses.

It is therefore the object of the invention to provide a press-concept by which materials can be deformed or shaped in a non-machining manner with highest precision.

### SUMMARY OF THE INVENTION

In a press with a plunger which is supported by an elastically deformable support structure so as to be linearly movable but otherwise rigidly engaged and with a drive arrangement for the controlled movement of the plunger is provided which includes no friction or antifriction support joints so that the plunger guide structure is not affected by position errors generated by oil films in bearings or wear of bearings generated by the high press forces which are effective during operation of the press and which could squeeze oil films out of bearing gaps.

The press according to the invention is suitable for the manufacture of minute surface deformations. It can be used particularly for the precise embossing of surface structures in the nanometer range. This combines the semi-conductor technology, the counter-fitting-safe characterization of products particularly by embossing plungers provided with structures in the nanometer range, the manufacture of colorful iridescent surfaces, the manufacture of Bragg-gratings or Christmas tree structures. The press is also particularly suitable for the manufacture of laminar objects for example nano-embossed foils or for the structuring of surfaces of massive solid bodies for example as in the manufacture of coins.

The press according to the invention, to this end, includes a plunger which is guided and supported by elastically deformable elements, called herein spring means, without the use of any slide or roller bearings. A drive arrangement is provided for the controlled movement of the plunger. The drive arrangement may be simply a linear motor whose movable part is connected to the plunger and whose stationary part is arranged at the press frame. By omission of the roller or friction bearings for the plunger, the plunger can be guided in a particularly precise manner. There are no friction surfaces between which oil buffers have to be established. Oil buffers could be squeezed out during pressure or rest phases so that mixed or even dry friction occurs, which results in corresponding wear. This, specifically, is avoided by supporting the plunger via deformable elements, in particular spring means.

The spring means is preferably formed by a spring packet for example in the form of leaf springs which are deformed during movement of the plunger slightly in an S-shape. The leaf springs are arranged preferably transverse to the direction of movement of the plunger and are elastically bendable in this transverse direction. They are however stiff in their respective longitudinal direction. They provide for the plunger a parallelogram guide arrangement so that the plunger follows almost a linear movement, or, more accurately a pivot movement with a very large radius relative to its stroke length. The radius is preferably more than ten times the operating stroke performed by the plunger.

The plunger is associated with a drive arrangement which preferably is also formed without any joint. The drive arrangement may be a force-increasing transmission for example in the form of a spring stilt transmission. Such a transmission comprises for example a support member which is movable in a direction transverse to the direction of the plunger movement and which is connected at one side via one, two or several leaf springs to the plunger and at the opposite side via one, two or several leaf-springs to the machine frame. A transverse movement of the support member is therefore converted into a longitudinal movement of the plunger. For driving the support member, suitable linear drives are provided such as for example a linear motor.

The invention and advantageous embodiments thereof will become more readily apparent from the following description of the invention with reference to the accompanying drawings.

### BRIEF DESCRIPTION OF THE DRAWINGS

FIG. 1 shows schematically a force-conversion arrangement according to the invention,

FIG. 2 shows the plunger of the conversion arrangement according to FIG. 1 in a schematic bottom view,

FIG. 3 shows a section of a modified embodiment of the conversion arrangement according to the invention, and

FIG. 4 shows schematically another modified conversion arrangement.

### DESCRIPTION OF PARTICULAR EMBODIMENTS

FIG. 1 shows schematically a conversion arrangement in the form of a press 1 which may serve for example as coin press or another press for the high-precision deformation of work pieces. The press 1 may be used for example for the manufacture of workpieces with finely structured surfaces. Such a few structuring is for example the stamping of diffraction-active structures, for example, line structures with line distances in the range of micrometers or fractions of micrometers. If the stamping tool is provided with suitable very fine structured hard stamping inserts, for example, on the surfaces of metallic objects, structures can be generated in this way which, when illuminated by white light, can generate colorful light reflections.

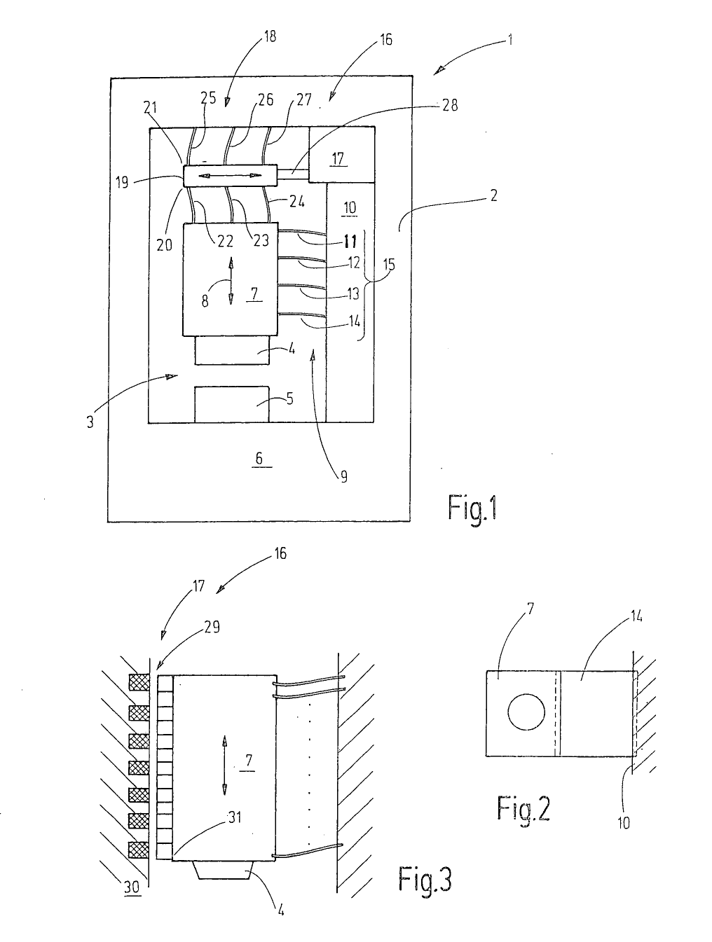

The press 1 includes a frame 2 which supports a suitable tool 3. The tool 3 includes an upper tool part 4 and a lower tool part 5 of which at least one is movably supported. In the embodiment shown, the lower tool part 5 is supported on a press table 6 or another suitable part of the press frame 2. The upper tool part 4 on the other hand is supported by a plunger 7 which is movable toward the press table 6 and away therefrom. The direction of movement is indicated in FIG. 1 by an arrow 8. The plunger 7 is supported so as to be movable in the direction of the arrow 8 by a guide arrangement 9. The guide arrangement 9 is formed by one or several elements, which are rigidly connected to the plunger 7 as well as to the press frame 2 or a mounting structure 10 provided thereon. In the present case, these elements are formed by springs 11, 12, 13, 14 of a spring packet 19. The springs 11-14 are for example leaf springs which each are connected with one end to the plunger 7 and with the other end to the mounting structure 10. While in the shown exemplary embodiment, only four springs 11 to 14 are shown, it should be understood that a different number may be chosen. In particular, it may be considered to provide a much larger number of individual leaf springs which, as shown in FIG. 1 for the springs 11-14, are arranged in parallel spaced relationship. The length of the individual springs 11 to 14 is preferably substantially greater than the length of the operating stroke to be performed by the plunger. If the operating stroke is for example one millimeter, leaf springs are provided which have a length of more than 10 mm. The individual springs 11, 12, 13, 14 are preferably identical. FIG. 2 shows the spring 14 which as shown may be in the form of a rectangular spring sheet of uniform thickness. Preferably, its width is the same as the width of the plunger 7 as shown in FIG. 2.

Between the individual springs 11-14 preferably a certain space is provided which, however, may be relatively small. The spaces may be for example in the area of the thickness of a spring 11-14.

The spring packet 15 forms a parallelogram guide structure for the plunger 7. The plunger 7 is consequently guided along a curved path whose curvature is determined by the length of the springs 11-14. With regard to the length of the deformation distance, that is, the length of the path over which the deformation of the work piece takes place, the length of the springs 11-14 or respectively the radius of the arc-like movement of the plunger 7 is large enough so that it can be considered to be a straight line movement.

For driving the plunger 7, a drive arrangement 16 is provided which, as shown in FIG. 1, may comprise a drive source 17 and a transmission structure 18. At least the transmission structure 18 and preferably also the drive source 17 have no friction or antifriction bearings or any other relatively moveable connecting elements wherein the movement is made possible by direct relative movement between surface areas. The transmission structure is formed in the present exemplary embodiment by a spring strut drive in the form of a toggle lever drive. It comprises a carrier 19 which has a side 20 facing the plunger 7 and an opposite side 21 facing away from the plunger 7. Between the carrier 19 and the plunger 7 leaf springs 22, 23, 24 are arranged which serve as the spring struts. The leaf springs are connected with one of their ends to the carrier 19 while their other ends are rigidly connected to the plunger 7. The number of individual springs 22, 23, 24 is selected as needed. On the opposite side 21, spring elements 25, 26, 27 are provided which again are connected with one end rigidly to the carrier 19 and with their respective other ends to the frame 2 or a support structure associated with the frame 2. The springs 22-24 are arranged parallel to one another and also the springs 25 to 27 are arranged parallel to one another. Preferably, at opposite sides 20, 21 of the carrier 19, the springs are arranged at corresponding opposite locations so that they extend at an obtuse angle relative to each other.

The carrier 19 of the transmission structure 18 is connected to the drive source 17 by a mechanical connecting element 28 which provides to the carrier 19 a stroke controllable transverse movement resulting in a stroke controllable movement of the plunger 7. The movement directions are marked in FIG. 1 by arrows.

The press 1 described above operates as follows:

During operation, the drive source 17 operates the carrier 1 at a controllable back and force movement. The carrier 19 in the process deforms the springs 22 to 27 and thereby changes the obtuse angle formed between the individual pairs of opposite spring struts. Because of the very high stiffness of the spring struts 22 to 27 in longitudinal direction, the plunger 7 is moved up and down in the direction of the arrow 8 whereby it can generate a very large force for causing deformation of a work piece. The work piece deformation may reside for example in ultra-fine embossing structures which form for example diffraction active structures on a work piece surface, for example, on the surface of a coin. The springs 11-14 provide for a pre-use sideward guidance of the plunger 7.

The press 1 may also be used for performing other particularly precise embossment or stamping procedures. For example, ultra-fine masks for the semiconductor manufacture can be produced by mechanical deformations in this way.

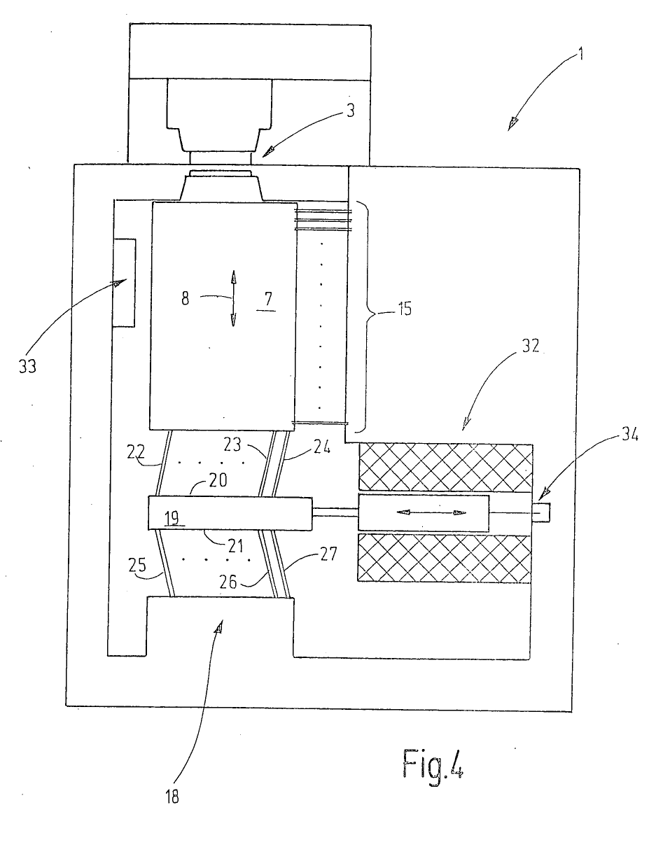

FIG. 3 shows a modified embodiment, wherein the plunger 7 cooperates directly with the drive source 17, which in the shown example is a linear motor 29. For example, its stationary armature 30 is directly connected to the machine frame 2 whereas the movable part 31 is connected to the plunger 7. But also other direct drive structures may be used for driving the plunger. For example, piezo-electric drives may be used for driving the plunger.

Another modified embodiment of the press 1 is shown in FIG. 4. Whereas in connection with the press 1 as shown in FIG. 1, the work piece 3 is arranged below the plunger 7, in the press 1 according to FIG. 4 the work piece 3 is disposed above the plunger 7. Concerning the guidance and the support of the plunger 7 and the design of the drive 18, the explanations provided above apply also in this case and the same reference numerals have therefore been used in FIG. 4 for the corresponding parts: The springs 22-27 form again toggle lever drives. For driving the carrier 19, a linear motor 32 may be provided as indicated schematically in FIG. 4. In addition, the plunger 7 may be connected to a position sensor 33, which senses the plunger position and supplies this information to a control unit which may be used for controlling the operation of the linear motor 32. Alternatively, or additionally, the linear motor 32 may be provided with its own position sensor 34 which is also connected to the control unit in order to precisely position the plunger 7.

The deformation arrangement according to the invention comprises a plunger 7, which is essentially linearly adjustably supported by at least one elastically deformable element but which is otherwise rigidly supported.

A drive arrangement 16 is provided for the predetermined, preferably stroke-controlled, movement of the plunger 7. The drive arrangement 16 may include a drive 18 which preferably does not include any friction or antifriction bearing joints. By the omission of friction or antifriction guide or bearing structures, particularly in the plunger guide structure and preferably also in the drive arrangement 16, position errors resulting from varying lubricating oil support films and from wear caused by the application of the high press forces as they usually may occur by displacement of the oil films from bearing gaps are avoided.

What is claimed is:

1. A press particularly for manufacturing workpieces with diffraction-generating structures, comprising:
a frame (2),
a plunger (7) supported on the frame (2) by spring means (15) so as to be movably guided for back and forth movement thereof, and
a drive arrangement (16) for the controlled movement of the plunger (7).

2. A press according to claim 1, wherein the spring means (15) is a packet of springs.

3. A press according to claim 1, wherein the spring means (15) comprises leaf springs (11, 12, 13, 14), which are arranged parallel to one another and which are connected with one of their ends to the plunger (7) and with their other ends to a stationary support structure (10) of the frame (2).

4. A press according to claim 1, wherein the direction (8) is a pivot direction provided by the spring means (15).

5. A press according to claim 2, wherein the plunger (7) is supported exclusively by the spring packet (15).

6. A press according to claim 1, wherein the drive arrangement (16) is a spring strut drive (18).

7. A press according to claim 6, wherein the spring strut drive (18) includes a spring carrier (19) which is movable in a direction transverse to the movement direction (8) of the plunger (7), the spring carrier (19) being supported by a first set of leaf springs (22, 23, 24) connected with one of their ends to one side (20) of the spring carrier (19) and with their other ends to the plunger (7) and, at the opposite side (21) of the spring carrier (19), by a second set of leaf springs (25, 26, 27) extending to a support structure associated with the frame (2).

8. A press according to claim 7, wherein the leaf springs (22, 23, 24) of the first set of springs at one side (20) extend parallel to one another and the leaf springs (25, 26, 27) of the second set of springs at the other side (21) extend parallel to one another.

9. A press according to claim 7, wherein the spring carrier (19) is connected to a linear drive (32).

10. A press according to claim 9, wherein the linear drive (32) is a linear motor.
